(19) United States
(12) Patent Application Publication
(10) Pub. No.: US 2012/0223100 A1
(43) Pub. Date: Sep. 6, 2012

(54) BOTTLE CAP FOR DISPERSING POWDERED SUPPLEMENT IN SITU

(76) Inventors: Christopher H.Y. Simonian, Sherman Oaks, CA (US); Jeannine Simonian, Sherman Oaks, CA (US); Ian J. Fettes, June Lake, CA (US); Robert E. Evans, Sierra Madre, CA (US)

(21) Appl. No.: 13/431,130

(22) Filed: Mar. 27, 2012

Related U.S. Application Data
(63) Continuation-in-part of application No. 12/983,813, filed on Jan. 3, 2011, now Pat. No. 8,141,700.
Application No. 12/983,813 is a continuation-in-part of application No. 12/789,861, filed on May 28, 2010, now Pat. No. 8,083,055.

(51) Int. Cl. B67D 7/78

(52) U.S. Cl. 222/145.1

(57) ABSTRACT

A dispensing cap system for dispensing a supplement material through a bottle neck opening and into the bottle. An exemplary embodiment includes a cap configured for connection to beverage bottle necks of different sizes. A seal member is arranged to provide a liquid seal against the neck opening. A valve member passes through a storage member attached to the cap, and is configured for movement between a storage position and a dispensing position, in which passage is permitted of the supplement material from the storage member into the bottle. A nipple member may be positioned over the valve member to allow the bottle contents to be utilized or consumed.

### CROSS REFERENCE TO RELATED APPLICATION(S)

This application is a continuation-in-part of U.S. patent application Ser. No. 12/983,813, filed Jan. 3, 2011, which is a continuation-in-part of U.S. patent application Ser. No. 12/789,861, filed May 28, 2010, each of which are incorporated by reference herein and from each of which priority is claimed.

### BACKGROUND OF THE INVENTION

### Field of Technology

Addition of supplements (powder, liquid or other form) to a beverage container is becoming increasingly popular. For example, powdered or liquid supplements may be stored in an assembly which is fitted to the neck of the container, to release the supplement into a container of water, to be consumed by the user.

International Application WO 2011/098865 to Fontana discloses a container closure with a rupturable membrane that is pierced by a plunger. Similarly, International Application WO/2010/028172 to Valentine discloses a cap that includes a device for piercing a capsule as the cap is threaded onto a bottle.

U.S. Pat. Nos. 6,962,254 and 6,820,740 to Spector discloses a parseable membrane, which may be pierced by a bottle top or by a plunger.

U.K. Patent Application GB 2471994 to Ken-Te Chen discloses a cap that cuts into and pushes a bottom wall.

Each of these devices may be inconvenient for use and/or may increase a risk that parts of the material being pierced may be released into a person's drink, and/or may hinder mixing of fluid and supplement material. The use of a piercing device may also increase a risk that a person or child who mishandles the device may be injured by the piercing device. In addition, the use of a pierceable material may increase a difficulty in recycling and/or reusing the device.

What is needed is a supplement storage cap that enables mixing of supplement with a beverage that is safe and convenient, and which more preferably includes one or more of the advantages of being: easy to fill, inexpensive, reliable, interesting to look at, easy to use, and potentially adaptable to varying sizes of beverage bottles.

### SUMMARY OF THE INVENTION

In an embodiment, there is a dispensing cap system for dispensing a supplement material through a bottle neck opening and into the bottle. The system may include the cap system along with the bottle, or just the cap system. The system may also be combined with supplement stored therein or without supplement therein to be filled later by a user.

An exemplary embodiment includes the cap, which may be configured with circumferentially arranged fingers at a lower end for connection to beverage bottle necks of different sizes, e.g., by engaging threads on the bottle neck. A seal member preferably of rubber is arranged to provide a liquid seal against the bottle's mouth or neck opening, and to fit inside the cap. The cap also has a storage member connected to it, and/or forms or is part of a storage compartment, where the supplement may be kept until use.

The cap system may also include a nipple for drinking liquid from the bottle, the nipple being of similar configuration to a standard water bottle or sports bottle nipple. There may also be a valve member, preferably cylindrical and hollow, having an upper portion preferably inside the nipple, and a lower portion with an opening or openings for communicating the storage compartment and thus the supplement with contents of the bottle. The valve may pass through the storage member or compartment which is positioned around the valve, and may be configured for movement between a storage position and a dispensing position. In the storage position, supplement and beverage cannot mix. In the dispensing position, the supplement material is permitted to pass from the storage member into the bottle for mixing with the bottle's contents and if desired, contents from the bottle may pass into the container too. The valve is preferably normally closed, i.e., normally in the storage position, and preferably actuated by pressing down on the nipple until the valve's opening or openings are registered with the storage compartment, i.e., the dispensing position. The bottle may then be shaken to mix the liquid and supplement, and then the user may move the nipple fully upward to a drinking position.

### BRIEF DESCRIPTION OF THE DRAWINGS

The system's features and advantages will readily be appreciated by persons skilled in the art from the following detailed description when read in conjunction with the drawings wherein:

FIGS. 1A-1C are exploded views of an exemplary embodiment of a bottle cap dispensing system.

FIG. 2 is a cutaway view of an exemplary dispensing cap system as installed on a bottle, with the system in a filled state.

FIG. 3 is a cutaway view similar to FIG. 2, but with the valve member in a dispensing state or position.

FIG. 4 is a cutaway view similar to FIG. 3, but with the cap nipple pulled up and in an open state relative to the valve member.

FIG. 5 is a cutaway view of a bottle of a large neck opening size in relation to the bottle shown in FIG. 2, with an exemplary embodiment of the cap system installed on the bottle neck.

FIG. 6 is an exploded view of an alternate embodiment of a bottle cap dispensing system.

FIG. 7 is a cutaway view of the alternate embodiment of FIG. 6 in assembled condition.

FIGS. 8, 9 and 10 are cutaway views of the alternate embodiment of FIG. 6, shown in an engaged position on three exemplary bottle types.

FIG. 11 is a cutaway or sectional view of a further embodiment of the cap system, showing an exemplary dispensing cap system for installation on a bottle as in prior embodiments, with a nipple and valve member in a shipping and/or storage position.

FIG. 12 is a cutaway or sectional view of the embodiment of FIG. 11, but with the nipple moved downward so that the valve member is in a dispensing state or position.

FIG. 13 is a cutaway or sectional view of the embodiment of FIG. 11, but with the nipple pulled up and in an open state relative to the valve member.

FIG. 14 is an exploded perspective view of the cap system of FIG. 13, but with a seal member assembly in an assembled state.

FIG. 15 is a perspective view of the cap system of FIG. 13 in a fully assembled state.

FIG. 16 is a perspective and partial view of the seal member assembly of the embodiment of FIG. 11 and enlarged in relation to FIG. 14 for better viewing of details of the seal member assembly.

FIG. 17 is a sectional view of an alternate embodiment of a bottle cap dispensing system.

FIG. 18 is an exploded perspective view of the bottle cap dispensing system, according to the embodiment of FIG. 17.

FIGS. 19A and 19B are illustrations of a nipple of the embodiment of FIG. 17.

FIG. 20 is a sectional view of a storage member of the embodiment of FIG. 17.

FIG. 21 is a perspective view of a cap of the embodiment of FIG. 17.

FIG. 22 is a sectional view of the cap of the embodiment of FIG. 17.

FIGS. 23A and 23B are side and top perspective views, respectively, of a seal member of the embodiment of FIG. 17.

FIG. 24 is a sectional view of the seal member of the embodiment of FIG. 17.

FIG. 25 is a side view of the shuttle valve of the embodiment of FIG. 17.

FIGS. 26A, 26B, and 26C are sectional views which illustrate the cap system of FIG. 17 at a non-mixing position with a nipple lowered (shipment position), a mixing position with the nipple lowered (nondrinking position), and a mixing position with the nipple raised (drinking position), respectively.

### DETAILED DESCRIPTION

In the following detailed description and in the several figures of the drawings, like elements are identified with like reference numerals.

One exemplary embodiment is a bottle cap assembly, configured to fit beverage bottles of different neck dimensions, and to dispense a liquid or solid (or even gaseous) additive such as a nutritional supplement into the bottle contents. For example, the bottle cap assembly may be configured to fit onto both an Evian® water bottle of a relatively larger neck size and an Arrowhead® water bottle with a somewhat smaller neck size. In another embodiment, the bottle cap assembly may be configured to fit onto at least three water bottles of different sizes. These exemplary embodiments include a valve which the user pushes or pulls to release a supplement in powdered or liquid form into the bottle contents, and also remains in place for the user to drink through. The valve also closes and opens to allow the user to seal the bottle or drink from the bottle. Once the bottle contents have been consumed, the bottle cap is typically not re-used, in an exemplary embodiment. However, it could be cleaned and re-used, if desired.

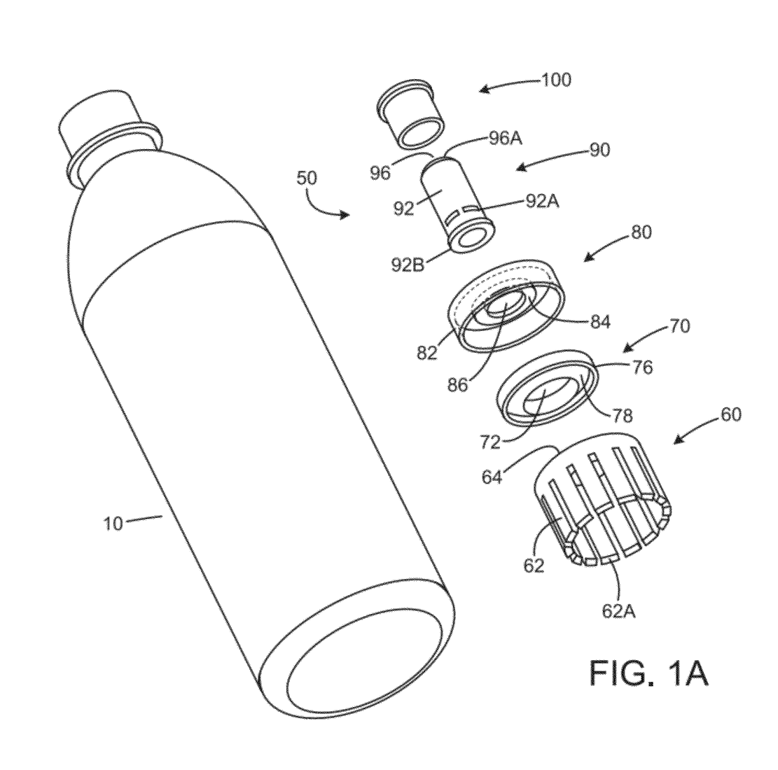

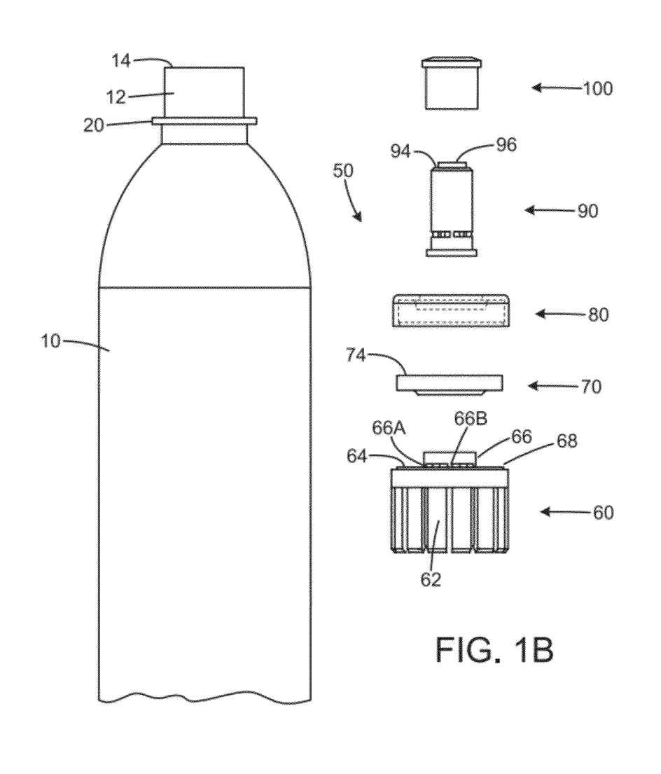

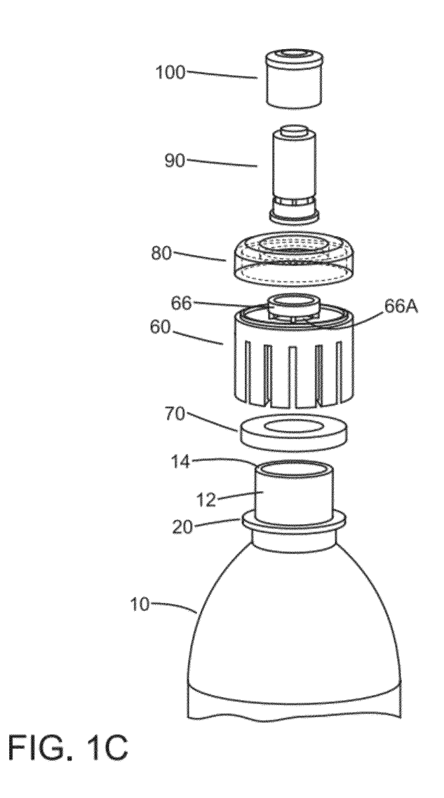

FIGS. 1A-1C are exploded views of an exemplary embodiment of a dispensing cap system 50. The cap system 50 is configured to seal to the mouth of a beverage bottle 10. In a typical embodiment, the bottle neck may have threads to allow a conventional threaded bottle cap or bottle cap and valve to be attached by threading to the bottle. The cap system 50 in such a case would be attached to the bottle neck after the conventional bottle cap has been removed. For simplicity, the threads on the bottle neck, above the neck flange, are not shown in the figures. The cap system 50 includes a cap 60 generally having a plurality of finger portions 62 projecting from a web portion 64. The distal ends of the finger portions 62 terminate in inwardly projecting barb or tab portions 62A, which may have sloped surfaces. The web portion 64 has a hollow upwardly projecting boss portion 66, i.e. projecting above the web portion 64 away from the finger portions 62. The boss portion 66 has a plurality of spaced dispensing openings 66A formed adjacent the web surface between ribs 66B, and these openings will allow the supplement material to pass through, as described more fully below.

The cap 60 may be fabricated of a plastic material such as polyethylene, polypropylene, polysterene, styrene, ABS, Delrin™ or Nylon™, and the finger portions 62 are thin and have some flexibility. The cap 60 and the length of the finger portions 62 is sized so that the tips of the finger portions 62 may flex outwardly as the cap 60 is pushed onto the neck 12 of the bottle, and the barb portions engage under the flange 20 extending from the bottle neck. The cap 60 further includes a circumferential vertical rib 68 extending upwardly from the web portion 64, of a smaller diameter than the diameter of the web portion 64, to provide an attach feature for attaching structure 80, described below. In this embodiment, cap 60 includes a connection structure for non-threading connection of the cap system 50 to a beverage bottle, by engagement with the bottle flange or collar. In this embodiment, the connection structure includes the finger portions 62 and the barb portions. This type of connection structure does not have to match the threads of the bottle neck, which may vary with different beverage vendors and/or bottle types. The number of finger portions 62 may vary in other embodiments. For example, fewer and relatively more rigid finger portions 62 may be used. In other embodiments, the connection structure may include finger portions 62 with barbs or teeth which engage the threads on bottle neck by sliding over some or all the threads as the cap system 50 is pushed onto the bottle neck, and locking in place without rotationally being threaded onto the threads of the bottle. A small or slight turn of the cap system 50 when the barbs slide of the threads of the bottle neck may help secure the cap system 50 and limit any play in the combination of the cap system 50 and bottle.

The cap system 50 also includes a seal member 70, shown for clarity in FIGS. 1A-1B above the cap 60, but actually sized to fit within the barrel of the cap 60. The seal member 70 is preferably fabricated of an elastomeric material, such as, by way of example only, silicone rubber, SBR, neoprene rubber, thermoplastic rubber (TPR) (molded rubber) or closed cell foam, and has a center opening configured for concentricity with the opening through the boss. Other features of the seal member 70 will be discussed below. Preferably, in all embodiments, the seal material is relatively compliant, e.g., preferably between 15 and 30 shore hardness, e.g., about 25 shore. Other shore values are not necessarily excluded.

A supplement storage member 80 is configured for attachment to web portion 64 of the cap 60, and, as will be described more fully below, defines the outer periphery of a storage volume for a quantity of a supplement in granular, powder or liquid form. The storage member 80 in this embodiment is a generally cup-like member, with a generally cylindrical sidewall portion 82 and a web portion 84 having an opening 86 formed therein. The storage member 80 may be fabricated of a semi-transparent or transparent plastic material such as, by way of example only, styrene, and is configured for attachment to the cap 60 by snap fit, adhesive, welding or other connection method. For example, the cap 60 top web surface may have a peripheral ridge with a groove extending above the web portion 64, which may be engaged in a snap fit by an inwardly extending corresponding feature on the bottom of the wall portion 82.

The dispensing cap system 50 further includes a shuttle valve 90 having a hollow generally cylindrical wall portion 92, and a top web portion 94 at one end thereof which extends across the end of the wall portion. A bottom flange 92B is formed at the distal end of the wall portion, and has an outer diameter larger than the diameter of the opening in the storage member 80. A tip 96 of reduced diameter relative to the wall portion 92 extends above the surface of the web portion 94. The sidewall of the tip has several ports 96A formed therein, and permit the beverage to pass through from the bottle when the valve is in an open position. The diameter of the wall portion 92 is sized in cooperation with the diameter of the opening 86 in the storage member 80, so that the cylindrical wall portion tightly fits within the opening in a sliding or even interference fit.

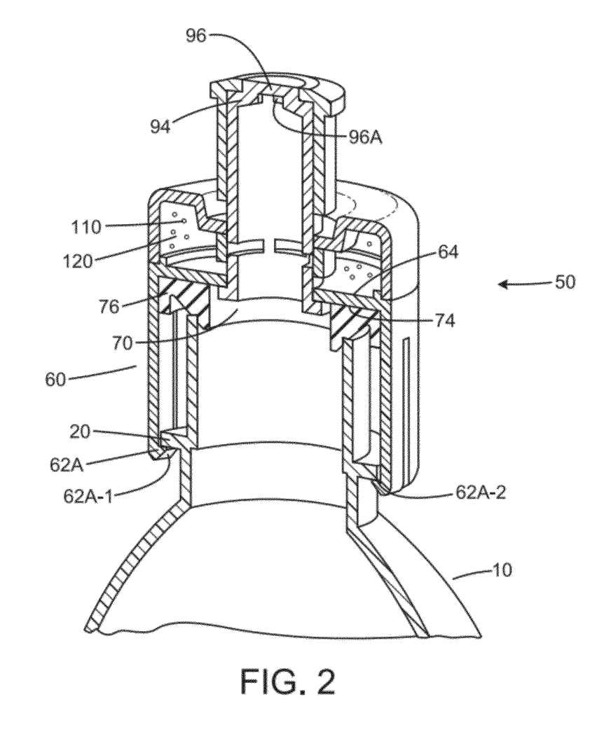

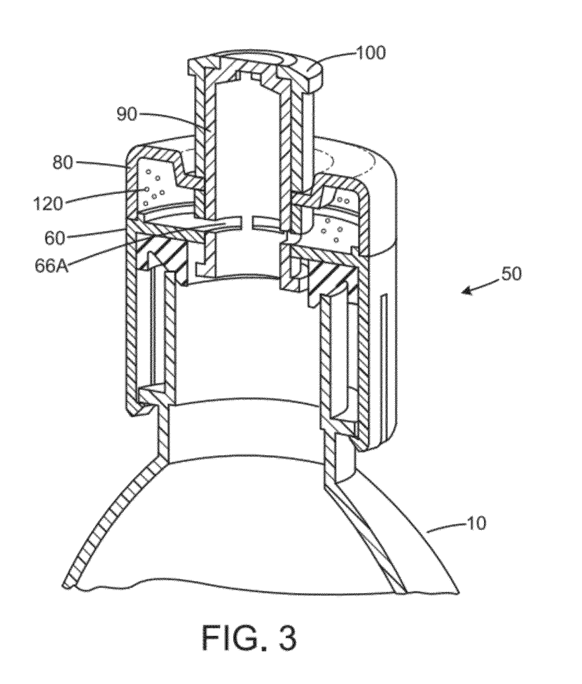

A nipple 100 is sized to fit over the shuttle valve 90. The shuttle valve 90 has a range of sliding movement within the storage member 80, and the nipple 100 has a range of sliding movement on the shuttle valve 90, such that, when the nipple 100 is in a closed position as in FIG. 2, the ports 96A are sealed by the nipple 100. In an open position as in FIG. 3, the nipple 100 does not cover the ports 96A, allowing liquid to pass through from the bottle, so the user can drink the beverage.

FIG. 2 is a cutaway view of the dispensing cap system 50 as installed on a bottle 10, with the system 50 in a filled state as delivered to the user. In this state, the valve 90 is positioned so that the lower flange 92B is in contact with the lower surface of the web portion 64 of the cap 60, and the nipple 100 is in a closed position relative to the nipple 100. The interior volume 110 of the storage member 80 has been filled with a quantity of supplement material 120. The openings 92A in the nipple 100 are blocked by the solid wall portion of the boss 66, preventing the supplement material from passing through the openings 92A.

Still referring to FIG. 2, the system 50 is installed on the bottle 10, with the barbed tips 62A of the finger portions 62 having been pushed over the bottle flange 20, with the angled surfaces 62A-1 facilitating the installation by transferring a flexing force tending to splay the tips 62A outwardly as user pushes the cap system 50 downwardly over the neck of the bottle and the surfaces 62A-1 contact the flange edge. Continued downward pressure on the cap system 50 results in the seal 70 coming into contact with the top lip of the neck and compressing somewhat to seal against the top lip of the opening. The barbed tips 62 then pass over the flange and lock the cap system 50 in place by engagement of the horizontal surfaces 62A-2 with the underside of the flange.

The seal member 70 includes a center opening 72 through which the bottle contents may pass, and a generally flat upper surface 74. The outer periphery of the seal includes a downwardly extending peripheral wall 76. The lower surface of the seal defines a tapered surface 78 defining a partial conical seal surface which may be contacted by the bottle neck lip when the cap system 50 is attached to the bottle neck. The conical seal surface has sufficient width relative to the bottle opening to seal a range of neck sizes, and also provide some adjustment to differences in the distance between the bottle neck flange and the top of the neck.

FIG. 3 is a cutaway view similar to FIG. 2, but with the shuttle valve 90 pushed downwardly, with the bottom end of nipple 100 contacting the surface of storage member 80. In the position or dispensing state shown in FIG. 3, the ports 92A in the valve member are at least partially aligned with slot openings 66A formed in cap boss 66. The supplement material 120 is dispensed through the aligned openings and ports, and into the liquid in bottle 10. The nipple 100 is still in a closed position relative to valve 90, so that the contents of the bottle cannot be drawn through valve 90. Depending on the tightness of the fit between storage member 80 and the valve, the user may tap nipple 100 and valve to cause the movement between the closed state shown in FIG. 2 and the dispensing state shown in FIG. 3. With cap system 50 in the dispensing state as in FIG. 3, the user may shake the bottle and assembled cap system 50 to ensure full dispensing of the supplement material from the storage member 80 into the bottle, and facilitate dissolving or mixing of the supplement with the bottle contents.

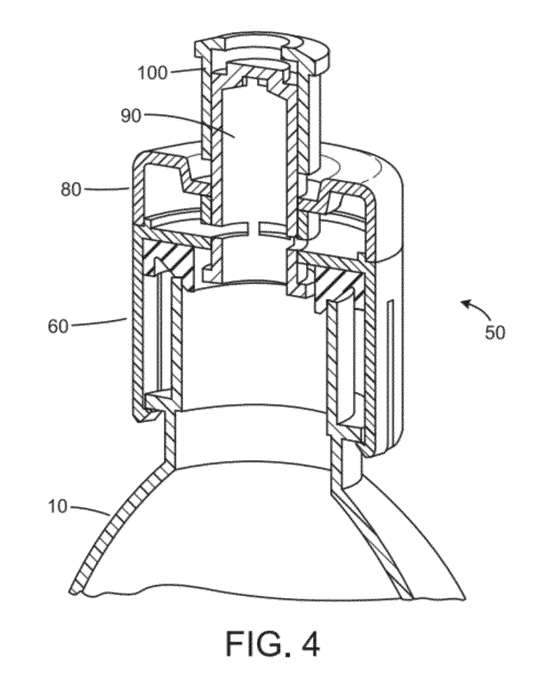

FIG. 4 is a cutaway view similar to FIG. 3, but with the nipple 100 pulled up and in an open state relative to the valve 90. In this position, the ports 96 on the tip of the valve are exposed, and provide ports through which the user may drink the bottle contents. In FIG. 4, the valve 90 has remained in the dispensing position relative to the storage member 80. The valve may be fitted with a projecting feature that allows the valve to be pushed from the storage position to the dispensing position, but due to engagement with the bottom of the cap 60 is prevented from being pulled back to the storage position. Alternatively, the valve member 90 may be raised to the storage position as the nipple 100 is opened.

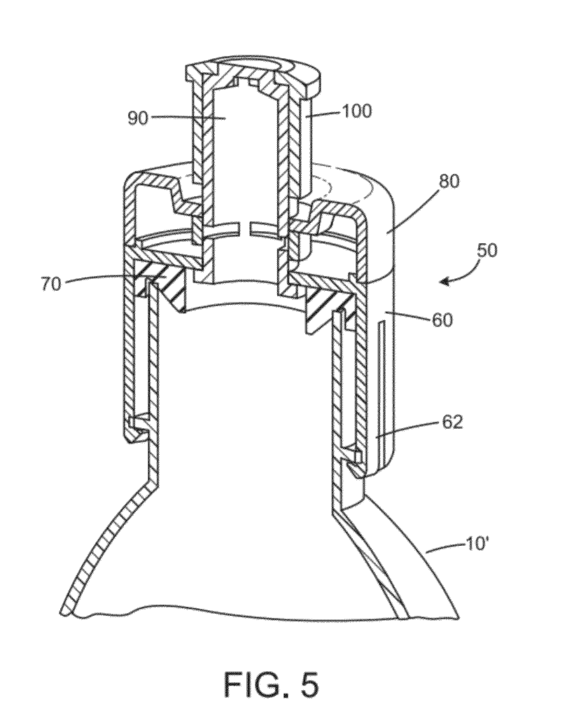

FIG. 5 is a cutaway view of a bottle 10′ with an exemplary embodiment of the cap system 50 installed on the bottle neck. The bottle 10′ has a somewhat larger neck diameter than that of the bottle 10, and yet the same cap system 50 is configured to seal and install on the bottle neck. This is due to the use of an expandable attach system as provided by the finger portions 62 of the cap 60, and the seal 70 with its seal surface broad enough to seal against necks of different sizes. In an exemplary embodiment the seal surface provided by the seal member 70 is conical, which can increase the seal pressure for larger diameter bottle neck openings, and/or accommodate differences in the distance between the top of the neck and the neck flange for different bottle types. Thus, instead of utilizing a threaded connection between the cap system 50 and the bottle neck, a connection which accommodates different neck sizes is employed.

An exemplary embodiment of a bottle cap dispensing system may accommodate bottle necks of different dimensions, so that one cap dispensing system can be used with several bottle sizes, e.g. with different neck heights (flange to neck opening), and various bottle neck opening diameters. Exemplary ranges are from 5 mm to 25 mm (neck height range) and 18 mm to 30 mm (diameter range of bottle neck openings). A typical diameter range is from 26.5 mm to 28 mm.

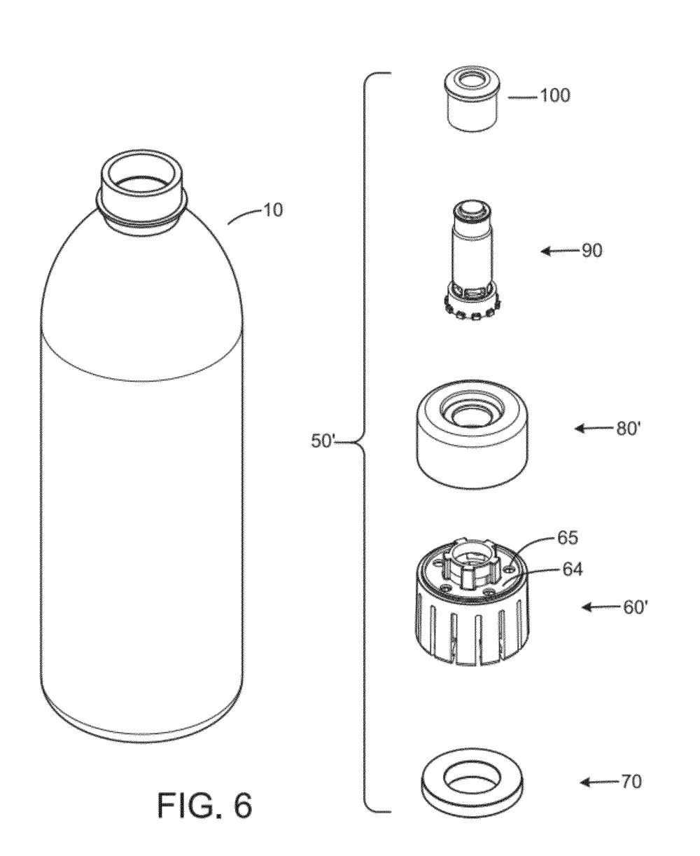

An alternate embodiment of a dispensing cap system 50′ is illustrated in FIG. 6. The alternate embodiment is similar to the embodiment illustrated in FIGS. 1A-5. However, the cap 60′ has a plurality of fill openings 65 formed in the web surface 64. The fill openings provide a means to allow the product to be dispensed to be filled into the supplement storage member 80′ after it has been attached or assembled to the cap 60′. A liquid or powder supplement material can be loaded into the storage member 80′ through the fill openings, e.g. by pouring the supplement into the openings with the cap/storage member 80′ assembly in an inverted position. After the storage member 80′ has received the supplement load, the bottle seal member 70 is inserted into the cap 60′ and pushed against the bottom of the web surface to seal the fill openings. The capacity of the storage container 80′ is increased in relation to that of storage container 80 (FIGS. 1-5) by increasing the depth dimension in this exemplary embodiment.

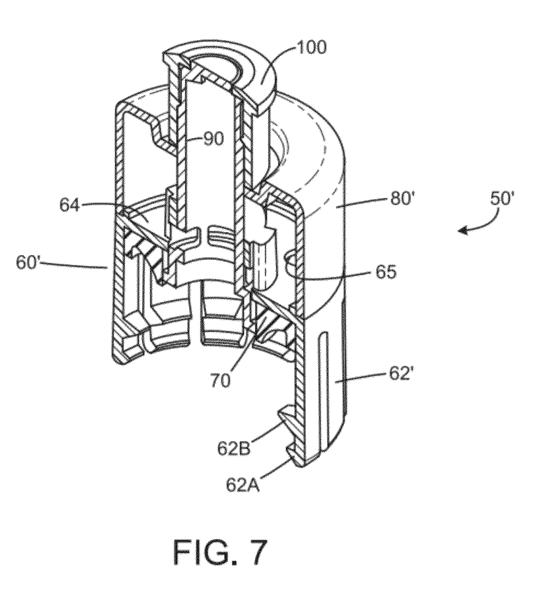

The cap system 50′ of FIG. 6 is further illustrated in the assembled, cut-away view of FIG. 7. Here the seal member 70 is shown in the sealed position, closing off the fill openings 65 formed in the cap surface 64.

FIG. 7 illustrates another feature of the bottle cap system 50′. Since some bottles have different neck-flange-to-neck-top-surface dimensions, at least some of the finger portions 62 of the cap 60′ are formed with two sets of barb portions, the barb tip 62A and an intermediate barb portion 62B. In the disclosed embodiment, each of the finger portions 62 is formed with the barb tip portion and the intermediate barb portion. In other embodiments, fewer than all the finger portions 62 may be fabricated with both, one, or none of the barb portions. Moreover, in other embodiments, some of the finger portions 62 may have only a tip barb portion, and others may have only an intermediate barb portion.

Use of the intermediate barb portions 62B with the tip barb portions 62A enables the cap system 50′ to accommodate even more variations in the bottle neck. For bottle necks with relatively smaller distances from the bottle opening surface against which the bottle cap assembly will seal to the bottle neck flange, the intermediate barb portions 62B may engage the flange to hold the cap assembly in place. For other bottle necks with relatively larger flange distances, the barb tip portions may engage the flange to hold the cap system 50′ in place.

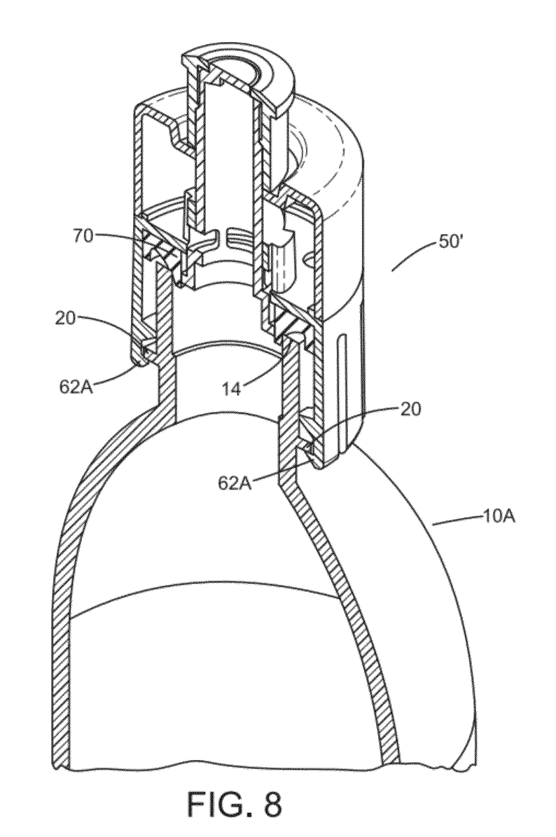

The versatility of the bottle cap system 50′ in accommodating bottle necks of different neck opening sizes and flange dimensions is illustrated in the cutaway views of FIGS. 8, 9 and 10. Here, the bottle 10A has a relatively longer distance between the flange 20 and the neck opening surface 14. The cap system 50′ is secured to the bottle by engagement of the tip barb portions with the flange 20. The neck opening of the bottle also has a relatively smaller diameter, with the surface 14 engaging the seal closer to the inward edge of the seal.

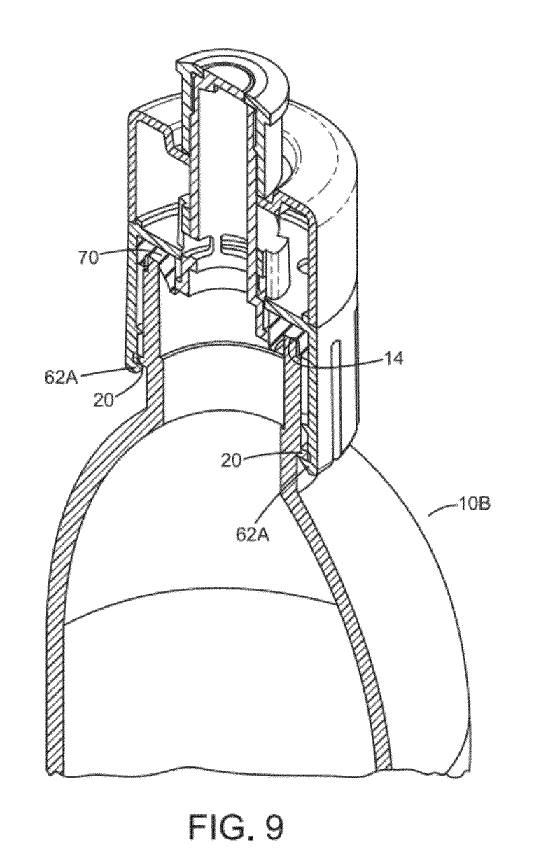

FIG. 9 shows the cap system 50′ in sealed position on the neck of another bottle 10B, this bottle having a somewhat larger neck opening diameter than that of bottle 10A, so that the neck surface 14 engages the seal surface of the seal member 70 in a position further away from the center of the seal member 70. However, the distance from the neck opening to the flange 20 is still relatively large, and the tip barb portions 62A are engaging the flange to hold the assembly 50′ in sealed position to the bottle neck.

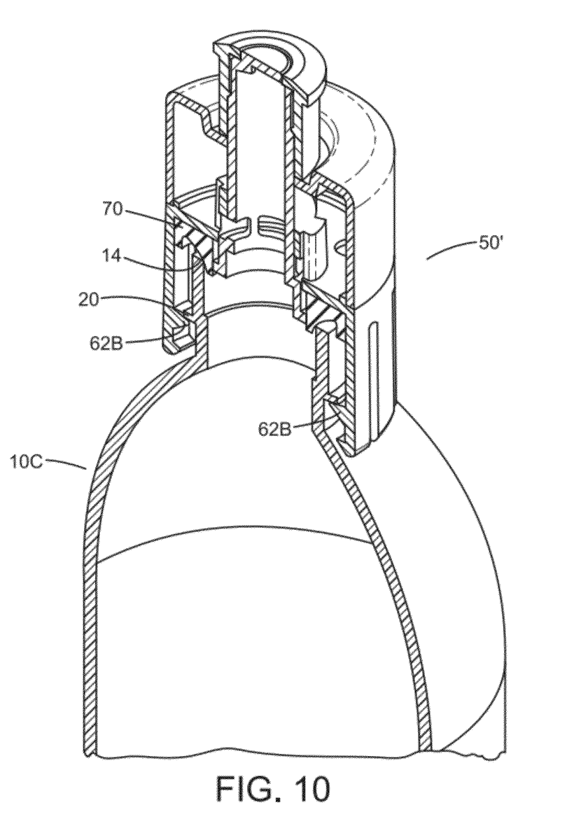

FIG. 10 shows the cap system 50′ in sealed position on the neck of yet another bottle 10C, this bottle, having a somewhat smaller neck opening diameter than that of bottle 10C, so that the neck surface 14 engages the seal surface of the seal member 70 in a position closer to the center of the seal member 70. However, the distance from the neck opening to the flange 20 is relatively smaller than that of bottles 10A and 10B, and the intermediate barb portions 62B are engaging the flange to hold the assembly 50′ in sealed position to the bottle neck.

In the embodiment 50′, the cap 60′ is provided with two barb positions relative to the bottle neck opening 14, i.e. the barb position of tip portion 62A and the barb position of intermediate barb portion 62B. In other embodiments, more than two barb portions positions may be provided, either on each finger portion 62 or at staggered finger portions 62. This may provide a single bottle cap system configured to accommodate more than two or three different bottle sizes. The bottle sizes are typically determined by a drink manufacturer, say a bottled water purveyor, sports drink purveyor or other drink vendor. Providing flexibility in the dispensing cap system to accommodate multiple bottle types provides the advantage of reducing the number of different types of dispensing cap systems needed to fit to the multiple bottle types.

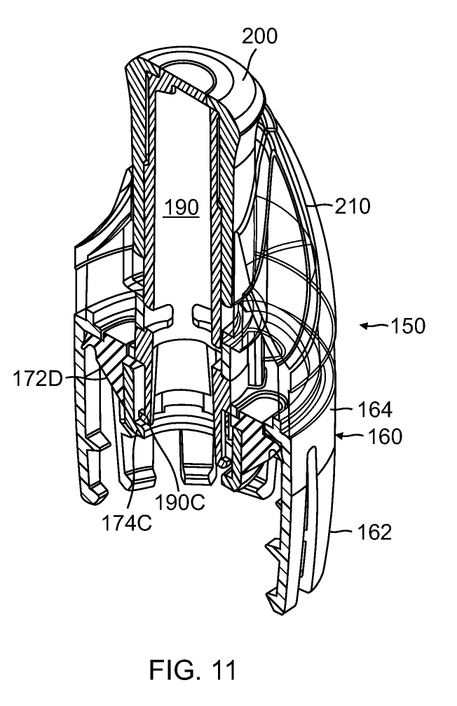

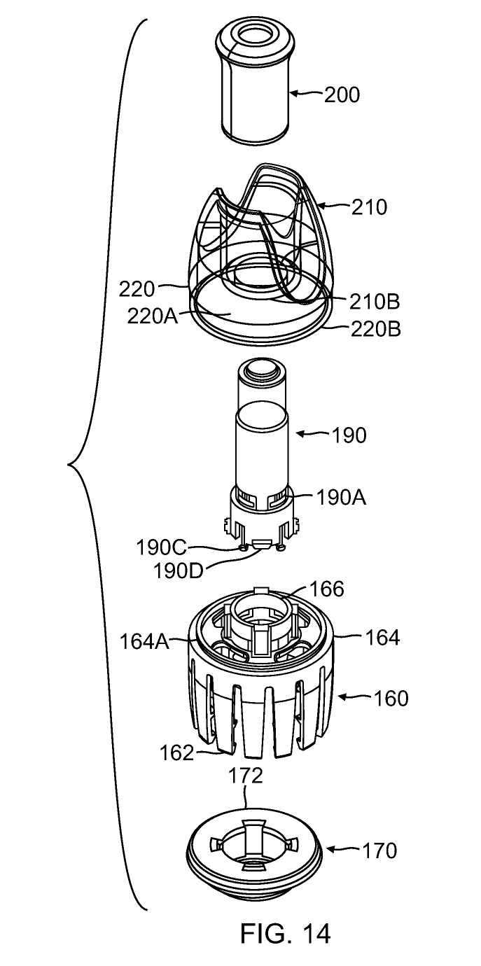

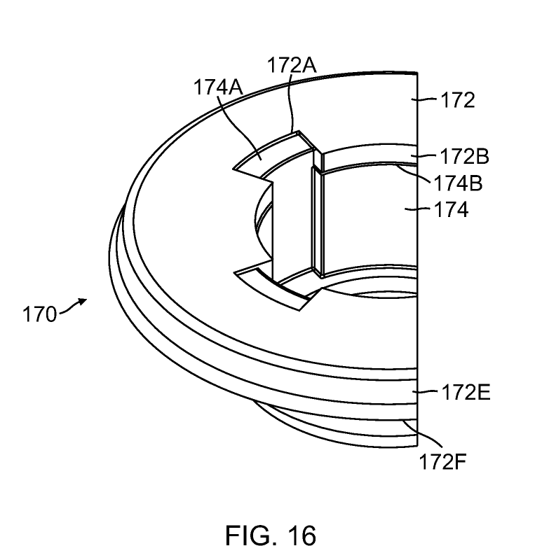

In another embodiment shown in FIGS. 11-16, a cap system 150 has similar overall function to the cap system 50 and other cap systems of the prior embodiments. One important difference is that a shuttle valve 190 of this embodiment will lock into position when moved (pressed) into its lowermost or low position, thereby remaining fully open to the supplement storage compartment in spite of shaking during mixing of bottle contents (e.g., liquid) and storage compartment contents (e.g., supplement), and in spite of movement of nipple 200, and other usage and jostling. This promotes and/or ensures a good mix of water and supplement and use of all available supplement. In addition, the cap system 150 may include a storage member 210 that is larger than storage member 80. and a seal member assembly 170 formed from multiple components. The seal member assembly 170 may include a rigid member 174 formed to engage the shuttle valve 190 in the locked position. The cap system 150 may have a cap 160 formed with openings 164D that permit supplement material to be added to the storage compartment member 210 while engaged with the cap 160. The seal member assembly 170 may cover and close the openings 164D when engaged with the cap 160.

Nipple 200 is the same or similar to nipple 100 and other nipples in the previous embodiments. It is sized to fit over shuttle valve 190. Around nipple 200 is a nipple seat and storage compartment member 210. This storage compartment member 210 is preferably of a rigid plastic, such as other rigid plastic members disclosed herein. Nipple 200 at its lower end preferably has a rib that mates with a rib of storage compartment member 210 to limit the upward movement of nipple 200, or by other means that are well known in the art for sports bottle type nipples.

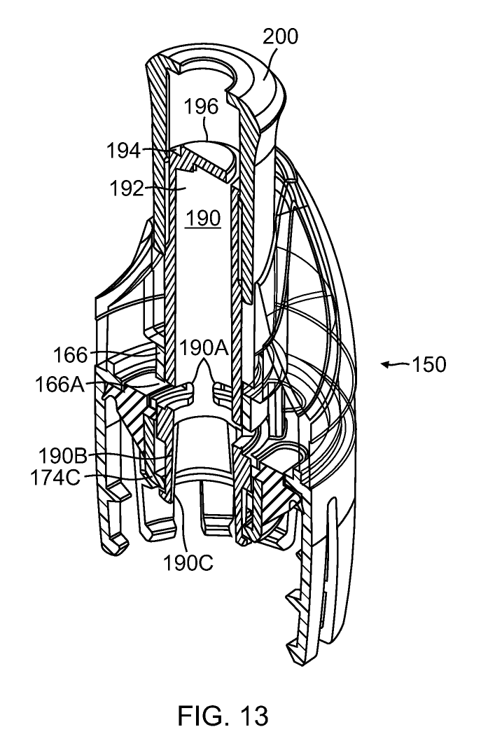

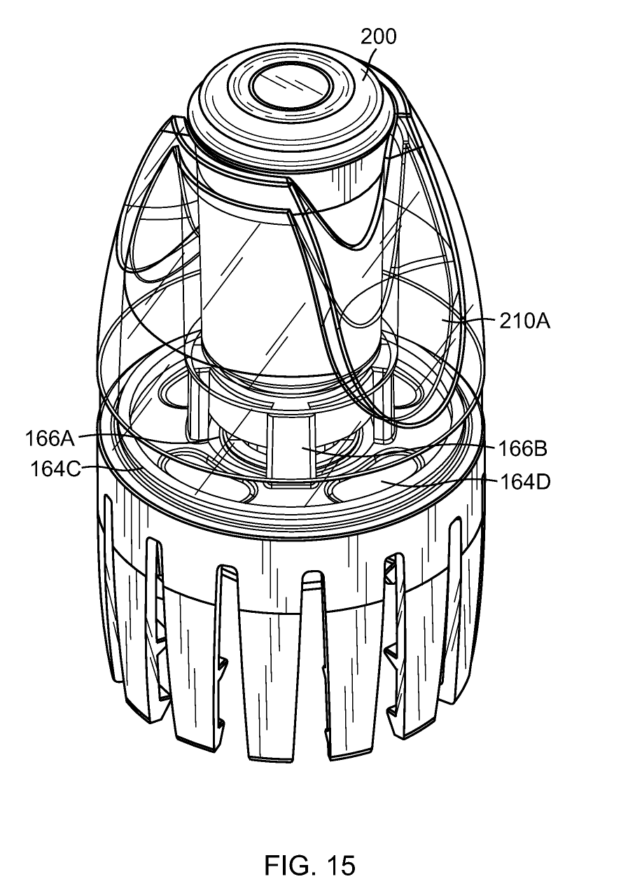

Storage compartment member 210 may have a hollow circumferential section 220 open at its lower end for mating with an upper portion of a cap 160 thereby forming a storage compartment 220A for supplement. The storage compartment member 210 may have two opposing curved indentations 210A so that even when the nipple 200 is in the downmost position (e.g., as shown in FIG. 15), portions of the nipple 200 are exposed to easily grasp the nipple 200 with a finger and opposing thumb to lift the nipple 200 from the closed position to an open position (uppermost position of the nipple 200, e.g., FIG. 13), so that a user may drink from the bottle. The storage member 210 has an inner bottom ring portion 210B to mate with an upper surface of ring 166 of web portion 164 of the cap 160. There may be small ribs to form a slight interference fit and thus a better seal to keep the supplement in the chamber.

In this embodiment, there is a cap 160 that functions the same or similar to the cap 60 and other caps of the prior embodiments. Generally, cap 160 has a lower portion with a plurality of finger portions 162 projecting from a web portion 164. The finger portions 162 are the same or substantially the same as in the prior embodiments, and preferably as depicted here with two barbs or tabs that operate the same as in the prior embodiments, forming an attach portion for attaching the cap system 150 and in particular the cap 160 to the bottle. The web portion 164 has a hollow upwardly projecting ring portion 166, i.e. projecting above the web portion 164 away from the finger portions 162. The ring portion 166 has a plurality of spaced dispensing openings 166A formed between adjacent posts 166B, and these openings will allow the supplement material to pass through when the shuttle valve openings 190A are aligned with the these openings 166A of the storage chamber, as described more fully below with reference to FIG. 13.

The cap 160 further includes an outer circumferential surface 164A and a circumferential vertical wall 164B extending upwardly from the web portion 164 and together defining the outer circumferential surface 164A. Surface 164A receives a bottom circumferential edge of the storage compartment member 210. The storage compartment member 210 has an inwardly projecting circumferential rib 220B that snap fits over and mates with an outwardly projecting circumferential rib 164C from wall 164B, rib 164C being of slightly greater diameter than that of rib 220B, thereby providing an attach feature of storage compartment member 210 to cap 160.

The cap system 150 may also include a seal member assembly 170 that fits into cap 160, i.e., sized to fit snugly within a barrel of the cap 160 formed by the fingers and pressed upwardly against an underside of the web portion 164 of the cap 160. The seal member assembly 170 is preferably two members, a seal member 172 and a rigid member 174. The seal member 172 is resilient and preferably fabricated of an elastomeric material, such as, by way of example only, thermoplastic rubber (TPR) (molded rubber), SBR, neoprene rubber, or closed cell foam, and has a center opening configured for concentricity with the opening through the boss. The rigid member 174 is preferably a rigid plastic of a type disclosed herein or other type of rigid member.

The rigid member 174 has upper tabs 174A that engage slots 172A of seal member 172 and an upper interior substantially annular surface 174B that receives a corresponding annular downwardly depending tab 172B of seal member 172. Seal member assembly 170 includes a center opening through which the bottle contents may pass, and a generally flat upper surface 74.

The outer periphery of the seal member 172 includes a downwardly extending peripheral wall 172E that also extends or tapers outwardly, and even more so at its lower and outermost portion 172F to frictionally engage the inner portion of the web member barrel, e.g., as shown in FIG. 11. This shape allows the seal member 172 to slide into the barrel relatively easily, but the outermost portion 172F tends to expand if one attempts to move it downward from the barrel. The seal member 172 also has an inwardly tapered lower surface 172D defining a partial conical seal surface which may be contacted by the bottle neck lip when the cap system 150 is attached to the bottle neck, e.g., as shown in the embodiment of FIG. 3.

The web portion 164 has an opening or openings 164D through which supplement can be inserted into the chamber. The chamber could also be filled in advance, prior to assembly, then snapped on to the cap 160 at the web portion 164, in which case the openings 164D would not be needed but could still be present. The member 210 may be fabricated of a semi-transparent or transparent plastic material such as, by way of example only, styrene, and is configured for attachment to the cap 160 by snap fit mentioned above, although adhesive, welding or other connection method could be used. As noted elsewhere herein, single use is preferred for the cap system 150, although multiple use is possible. Shipment with the chamber filled, or subsequent filling by the user are possible.

The dispensing cap system 150 further includes the shuttle valve 190 having a hollow generally cylindrical wall portion 192, and a top web portion 194 at one end thereof which extends across the end of the wall portion and is for mating with the nipple 200 when the nipple 200 is closed to flow of liquid. A bottom of the shuttle valve 190 has tabs or fingers 190B that have a gripping projection 190C at their ends. The gripping portions engage a bottom inner annular portion 174C of the rigid member 174 of the seal member assembly 170 to hold the shuttle valve 190 securely in the open position as best shown in FIG. 13. There are also boss surfaces or tabs 190D to act as downward motion stoppers that engage the upper portion of annular portion 174C.

A tip 196 of reduced diameter relative to the wall portion 192 extends above the surface of the web portion 194. The sidewall of the tip has several ports (e.g., such as shown as 96A in earlier embodiments) formed therein, and permit the beverage to pass through from the bottle when the valve is in an open position. The diameter of the wall portion 192 is sized in cooperation with the diameter of the opening in the storage member 210, so that the cylindrical wall portion tightly but slidably fits within the opening.

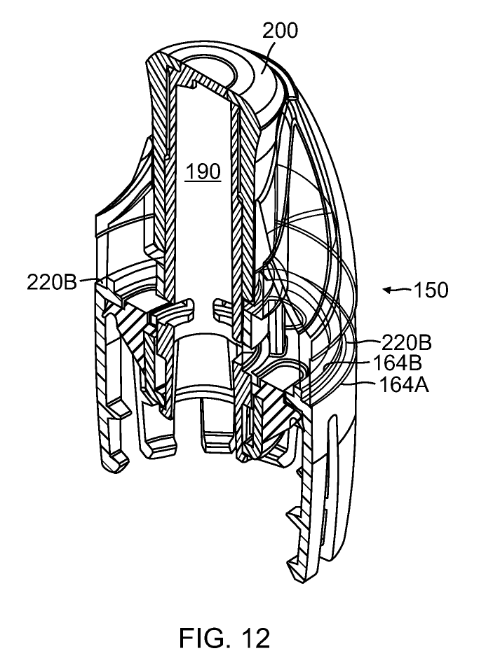

The shuttle valve 190 has a range of sliding movement within the storage member 210, and the nipple 200 has a range of sliding movement on the shuttle valve 190, such that, when the nipple 200 and shuttle valve 190 are in a closed position as in FIG. 11, the ports are sealed by the nipple 200. In an open position as in FIG. 12, the nipple 200 does not cover the ports 196A, allowing liquid to pass through from the bottle, so the user can drink the beverage.

In the shipping or storage state of FIG. 11, valve 190 is positioned so that the boss surfaces or tabs 190D may be positioned such that against the upper portion of annular portion 174C and act as temporary downward motion stoppers. However, friction also would act to prevent premature opening of the valve. Further, packaging for the cap system 150 in shipping and otherwise handling would preferably be such to help prevent premature opening of the valve. The interior volume of the storage member 210, when filled with a quantity of supplement material, cannot flow out through openings 166A because the openings 190A of the shuttle valve 190 are not aligned. They are blocked by the solid wall portion of the shuttle valve 190.

When the system 150 is installed on a bottle such as bottle 10, the nipple 200 and shuttle valve 190 may be pressed down by the user, resulting in the tabs 190D passing downward below the annular portion 174C and engaging the lower surface of the annular portion. This communicates the openings 190A in the shuttle valve 190 with the openings 166 in the web portion 194 and allows supplement to mix with liquid from the bottle. There is an annular gap between the openings 190A and openings 166 so that actual alignment of the openings 190A with openings 166 is not necessary for the system to operate, although alignment would be preferred. The user shakes the bottle until a good mix is achieved. The openings 190A positively stay in communication with the openings 166, thus allowing complete mixing.

FIG. 13 shows the drinking position of the nipple 200, which has been pulled upward to its topmost position, opening communication with the ports in the shuttle valve 190. The shuttle valve 190 stays down. Although the foregoing has been a description and illustration of specific embodiments of the subject matter, various modifications and changes thereto can be made by persons skilled in the art without departing from the scope and spirit of the invention. For example, a lesser preferred connection system would be threads instead of fingers with barbs or fingers with threads, but in such case the cap system 150 would have to be sized for a particular bottle. Such embodiments would not have the more universal attachment capability of the fingers with barbs. More fingers, such as ten, twelve or fourteen, are preferred as such fingers will have a smaller width relative to using fewer fingers, e.g., six. The finger and barb dimensions and material, and the number of fingers and barbs, and spacing between the fingers all affect the resiliency of the fingers. The resiliency is such that the downward force needed to apply the fingers to the bottle neck sufficiently to form a good seal between the seal member and bottle is less than the deformation point and failure point of the bottle. At least ten, or at least twelve or at least fourteen fingers helps to provide good flexibility and resiliency to the fingers to help reduce the downward force of application to the bottle, and yet achieve a strength of attachment to the bottle such that pulling up on the nipple 200 in order to drink will not pull the cap system 150 off of the bottle. The force required to apply the cap 160 to the bottle must be less than such force that would cause the user to apply so much resisting force to the bottle that the user would cause the bottle to be crushed or otherwise fail.

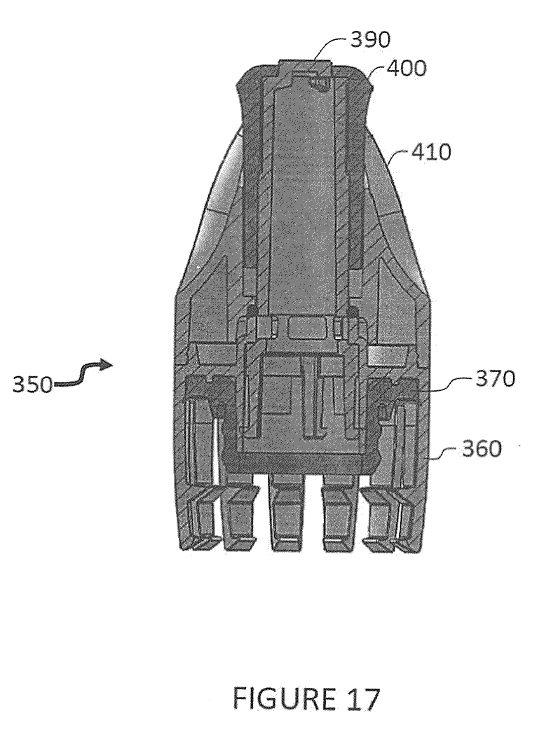

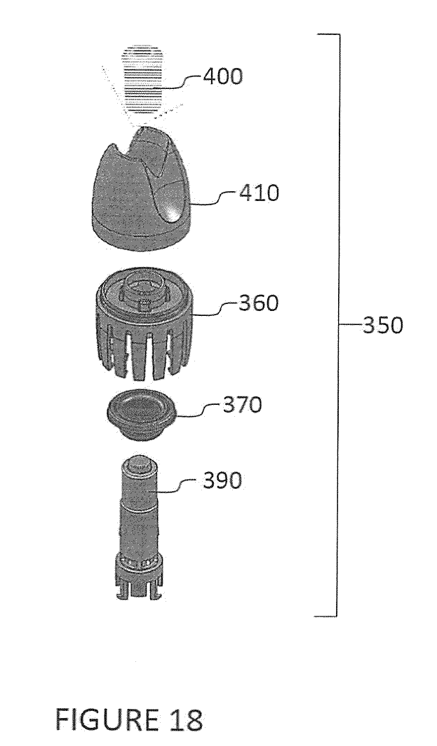

In another embodiment, which is shown in FIGS. 17-26C, a cap system 350 has similar overall function to the cap system 50, the cap system 150, and other cap systems of the prior embodiments. Like the cap system 150, a shuttle valve 390 can lock into position when moved (pressed) into a lower position, thereby keeping the supplement compartment 420A open and in fluid communication with a bottle connected to the cap system 350 to promote thorough mixing of the bottle contents, e.g., liquid and the storage compartment contents, e.g., supplement. As shown in FIGS. 17-18, the cap system 350 may include the nipple 400, the shuttle valve 390, a storage member 410, a cap 360, and a seal 370. The cap system 350 may differ from the cap system 150 in multiple ways. For example, the cap 360 preferably includes a support 364D that extends down a center bore of the cap system 150, that is configured to support the seal 370, and that is configured to engage the shuttle valve 390 in a locked position, thereby eliminating the seal assembly's rigid (support) member. A web portion 364 of the cap 360 preferably lacks the kidney shaped openings therein. The seal 370 may be formed from a single structure rather than multiple structures, and preferably lacks the kidney shaped bosses. The seal preferably also has an elongate downwardly depending portion that functions like a cork. Additional changes are described below and/or illustrated in FIGS. 17-26C that help ensure a good liquid tight seal, improve positioning of parts relative to each other, increase frictional resistance to allow the cap system 350 to more positively maintain a mixing, non-mixing, open, or closed state, increase storage capacity, and/or simplify manufacture or assembly.

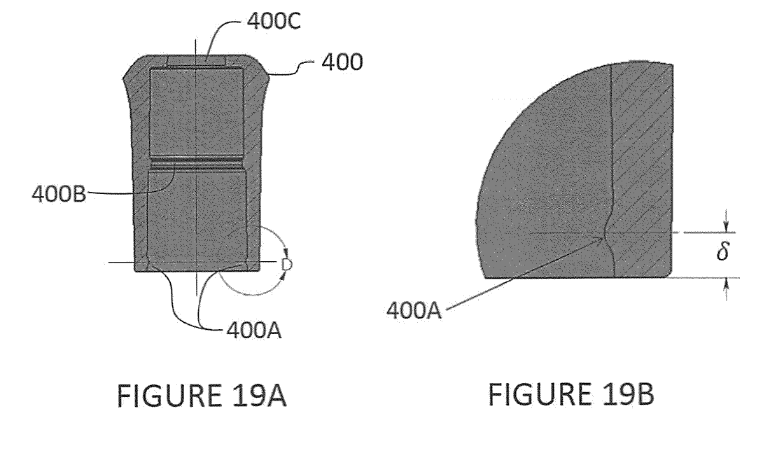

NIPPLE: The nipple 400 is the same or similar to nipple 100, nipple 200, and other nipples in the previous embodiments. As shown in FIG. 19A, nipple 400 preferably includes one or more nipple protrusions 400A, an interference line 400B, and a nipple opening 400C. The nipple 400 is preferably sized to fit over shuttle valve 390. Nipple 400 is configured to be inserted into and housed in storage member 410, which acts as a nipple seat. The nipple 400 is further configured as a sleeve over shuttle valve 390. Nipple 400 can be moved between an open (drinking) position in which the container contents communicate with the nipple opening and a closed position in which the container contents cannot pass out of the nipple. The one or more nipple protrusions 400A and the interference line 400B preferably extend radially inward toward a center axis of nipple 400 from an inner wall of the nipple. The one or more nipple protrusions 400A preferably are disposed proximate a lower edge of nipple 400, and are configured to frictionally engage the outer surface of shuttle valve 390 when nipple 400 is at a raised and/or open position. The nipple 400 may be made from low density polyethylene, among other materials.

FIG. 19B is an enlargement of the circled region ‘D’ in FIG. 19A. As shown in FIG. 19B, nipple protrusions 400A (nubs) may be disposed at a distance δ, which may be approximately 0.05 inches in a most preferred embodiment, from a bottom of nipple 400. In other less preferred embodiments, the distance δ may range between 0.01 inches and 0.1 inches. Other distances may also be used. These nubs or protrusions help frictionally engage an outer surface of shuttle valve 390 to hold the nipple in place with respect to the shuttle valve, so the nipple can stay in the drinking position until the user pushes the nipple down to the closed position where the inside top of the nipple engages the top of the shuttle valve.

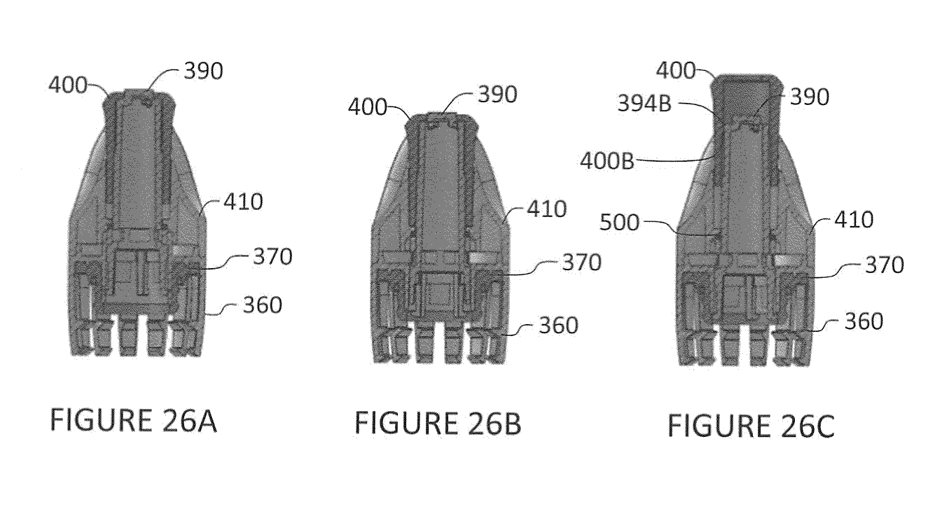

The interference line 400B may be configured to act as a stopper to limit upward movement of nipple 400 away from shuttle valve 390 to prevent nipple 400 from becoming removed from cap system 350 when nipple 400 is moved from a closed and/or lowered position to the raised and/or open (drinking) position. See FIG. 26C showing the shuttle valve's valve end flange 394B contacted by interference line 400B in the maximum upward position of the nipple with respect to the shuttle valve 390.In other less preferred embodiments, upward movement of the nipple 400 may be restricted by other means such as those well known in the art for sports bottle type nipples.

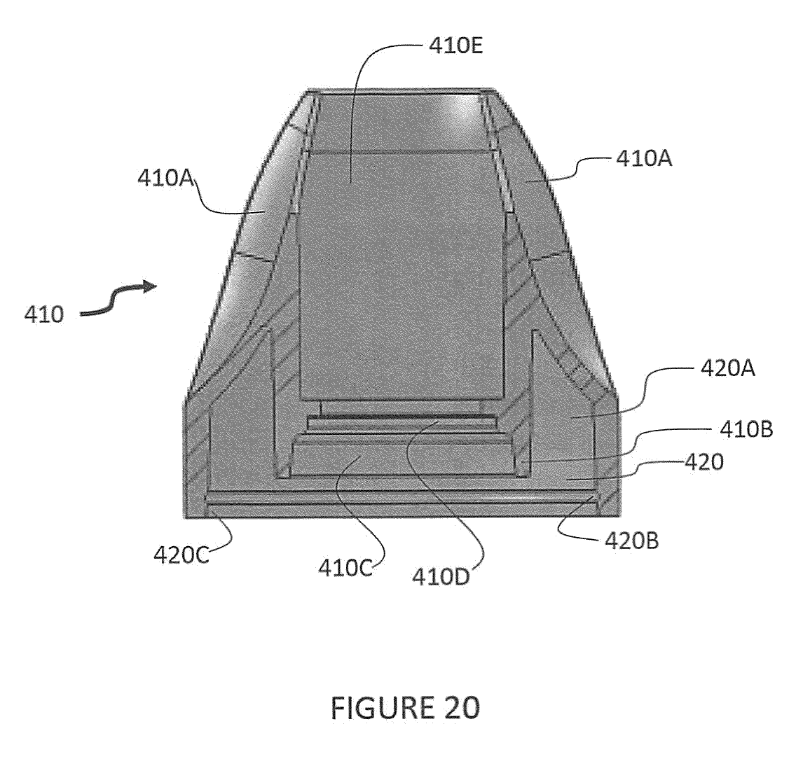

STORAGE MEMBER: Storage member 410 (or product container or storage container) is similar to and/or longer than the storage member 210. In a most preferred embodiment, storage member 410 may be formed from clear or tinted PET, although other materials may also be used. As shown in FIG. 20, storage member 410 preferably includes one or more indentations 410A, an inner ring 410B, an inner ring wall 410C, a groove 410D, a storage member channel 410E, a hollow circumferential section 420, a compartment 420A, and a mating part 420B formed on a peripheral wall 420C. The storage member 410 may preferably be formed using a rigid plastic, e.g., PET, such as clear or tinted PET, or if desired, opaque PET. As can be seen in the drawing, inner ring 410B extends further downward in this embodiment to provide greater storage capacity.

Hollow circumferential section 420 may be open at its lower end for mating with an upper portion of the cap 360 thereby forming the compartment 420A to hold supplement prior to and/or during mixing. Storage member 410 may have two opposing curved indentations 410A so that even when the nipple 400 is at its lowest position relative to the shuttle valve 390 (e.g., as shown in FIGS. 17, 26A, 26B), portions of the nipple 400 are exposed such that a user can easily grasp the nipple 400 with a finger and opposing thumb to lift the nipple 400 from the closed position to an open position (uppermost position of nipple 400, e.g., FIG. 26C), so that a user may drink from the bottle. The storage member channel 410E is sleeved over a bottom part of the nipple 400, which in turn is sleeved over shuttle valve 390.

The inner ring 410B and/or the inner ring wall 410C of storage member 410 preferably are configured to mate with an upper surface of a ring portion 366 of web portion 364 of cap 360. Inner ring wall 410C preferably flares outward to accommodate ring portion 366. Small ribs and/or indentations (or even threads) are preferably formed on the surfaces of inner ring 410B and ring portion 366 to form a seal to keep the supplement in the compartment 420A until the user wishes to mix the supplement with the bottle contents, e.g., fluid. Groove 410D may be disposed on or proximate to inner ring wall 410C, and may be formed to retain the o-ring 500 that assists with sealing a connection between storage member 410 and the shuttle valve 390 (see FIG. 26C). The o-ring may further provide frictional resistance between shuttle valve 390 and storage member 410 to keep the shuttle valve in the uppermost, nonmixing (shipping) position of FIG. 26A until the user is ready to mix the contents of the storage container and the bottle.

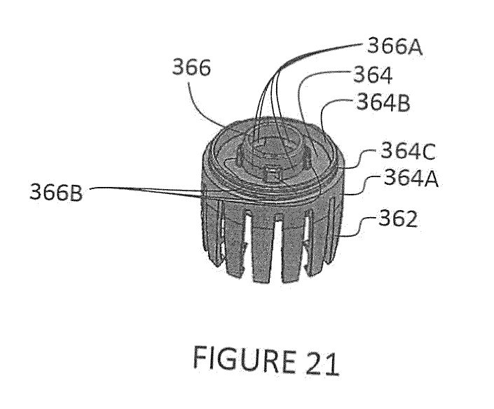

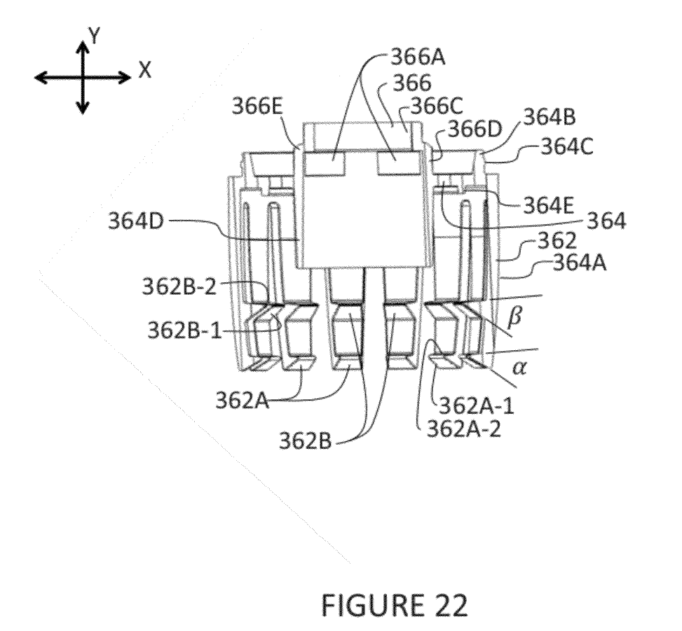

CAP: In this embodiment, cap 360 functions the same or similar to cap 60, cap 160, and other caps of the prior embodiments. As shown in FIGS. 21 and 22, cap 360 may include a bottle attachment portion or member, preferably formed as finger portions 362. Cap 360 preferably also has a web portion 364, a circumferential outer surface 364A, a circumferential vertical wall 364B, an engagement portion (e.g., a circumferential rib/indentation), and a ring portion 366 having one or more cap openings 366A. In this embodiment, preferably there are no kidney shaped holes, and the cap has a long sleeve down the center, eliminating the seal assembly's rigid member of other embodiments.

The cap 360 further includes an outer circumferential surface 364A and a circumferential vertical wall 364B extending upwardly from the web portion 364 that together define the outer circumferential surface 364A. Outer circumferential surface 364A is preferably configured to receive a bottom circumferential edge of storage member 410. The storage member 410 preferably has a mating part 420B formed on peripheral wall 420C. The mating part 420B preferably includes an inwardly projecting circumferential rib and/or inwardly opening indentation configured to engage and mate with an engagement portion 364C. The engagement portion 364C preferably is an outwardly projecting circumferential rib and/or an outwardly opening circumferential indentation of wall 364B on the cap 360 to help seal and secure the storage member to the cap, such as by a snap-fit so that the storage container snap fits onto the cap.

The cap 360 may further include a seal support 364D and a positioning flange 364E that each extend downward from the web portion 364 away from the ring portion 366. The seal support 364D (or sleeve) may be aligned with the ring portion 366, and the positioning flange 364E may encircle the seal support 364D and will support the seal. In a most preferred embodiment, the seal support 364D is a cylindrical, continuous shaft, and the positioning flange 364E is a wall that encircles the seal support 364D. In some embodiments, the seal support 364D may be composed of separate parts rather than a continuous shaft, and the positioning flange 364E may be composed of one or more tabs disposed on the web portion 364 between the seal support 364D and the finger portions 362 (not shown).

The seal support 364D or sleeve is preferably configured to extend through and support the seal member 370 to help prevent leakage between the seal support 364D and seal member 370 (see FIG. 22 and FIG. 17). The engagement between the seal member 370 and positioning flange 364E may further help to prevent leakage. When cap system 350 is engaged with a bottle, the seal support 364D of cap 360 and seal member 370 may extend into the mouth of a bottle. The seal support 364D may then brace the seal member 370 against the bottle opening and/or an inner wall of the bottle opening, so that the seal and seal support act like a cork in the bottle. In other embodiments, the seal member 370 may be abutted against an end of a bottle opening, or sleeved over an exterior surface of a bottle opening (not shown). The seal support 364D or sleeve also minimizes the possible leak paths around the seal.

The finger portions 362 may be similar to the finger portions 162, the finger portions 62, and/or the finger portions of other prior embodiments, and preferably operate similarly for attaching the cap system 350 to a bottle. Each of the finger portions 362 preferably extend from web portion 364, and include a first barbed tip 362A, and a second barbed tip 362B. Each of the first barbed tips 362A preferably include a first contact surface 362A-1 and a first engagement surface 362A-2. Each of the second barbed tips 362B may include a second contact surface 362B-1 and a second engagement surface 362B-2. Each first contact surface 362A-1 and first engagement surface 362A-2 may form an angle α, and each second contact surface 362B-1 and second engagement surface 362B-2 may form an angle β. In a most preferred embodiment, the angle α may be approximately 35 degrees, and the angle β may be approximately 40 degrees. In a most preferred embodiment, the first engagement surface 362A-2 and the second engagement surface 362B-2 may be angled at approximately a 5 degree angle with respect to the X-axis.

In a more preferred embodiment, each first contact surface 362A-1, first engagement surface 362A-2, second contact surface 362B-1, and second engagement surface 362B-2 may be varied in angle by up to 10 degrees. In other embodiments, the angle of each first contact surface 362A-1, first engagement surface 362A-2, second contact surface 362B-1, and second engagement surface 362B-2 may be varied by up to 30 degrees. Other embodiments may lack barbed tips, and may be attached to a bottle in other ways, such as being screwed onto a bottle, being inserted into the bottle neck similar to a stopper, being bound to a bottle, and/or clamped to a bottle neck.

While the finger attachment mechanism is preferred, in a less preferred embodiment, the attachment portion may comprise a threaded member that is screwed onto a bottle. The threaded member would have screw threads configured to engage threads of one or more types of bottles.

An embodiment that is inserted into a bottle like a stopper could simply be held in place by frictional resistance between an inner surface of the bottle and a component of the cap system 350, such as the seal member 370, or the seal support 364D. In other embodiments, the cap system 350 may have one of the disclosed attachment mechanisms with fingers but lack a valve system and/or lack a supplement storage, mixing and/or delivery system and may be a cap that is universally attachable to various bottle sizes.

The web portion 364 of the cap preferably includes hollow upwardly projecting ring portion 366, i.e. projecting above the web portion away from finger portions 362. The ring portion 366 may include the one or more cap openings 366A formed between adjacent posts 366B.

The ring portion 366 may further include an upper ring portion 366C, a ring portion shoulder 366E that extends outward from a center axis of the cap 360 and away from a base of the upper ring portion 366C, and a lower ring portion 366D that extends downward from the ring portion shoulder 366E to the web portion 364.

The upper ring portion 366C may be sized to sleeve over and permit sliding movement of the shaft portion 392 of the shuttle valve 390, but to prevent insertion of a valve base 396 into the upper ring portion 366C. The valve base 396 may be prevented from being inserted into the upper ring portion 366C, which may be configured to abut against a base web portion 396A of the valve base 396 when the cap system 350 is at a no-mixing position and the shuttle valve 390 is at an upper position relative to the cap 360. The lower ring portion 366D and/or the seal support 364D may each have an inner diameter sized to sleeve over and permit sliding movement of the valve base 396.

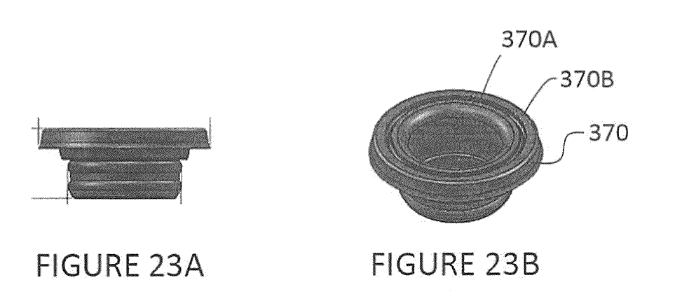

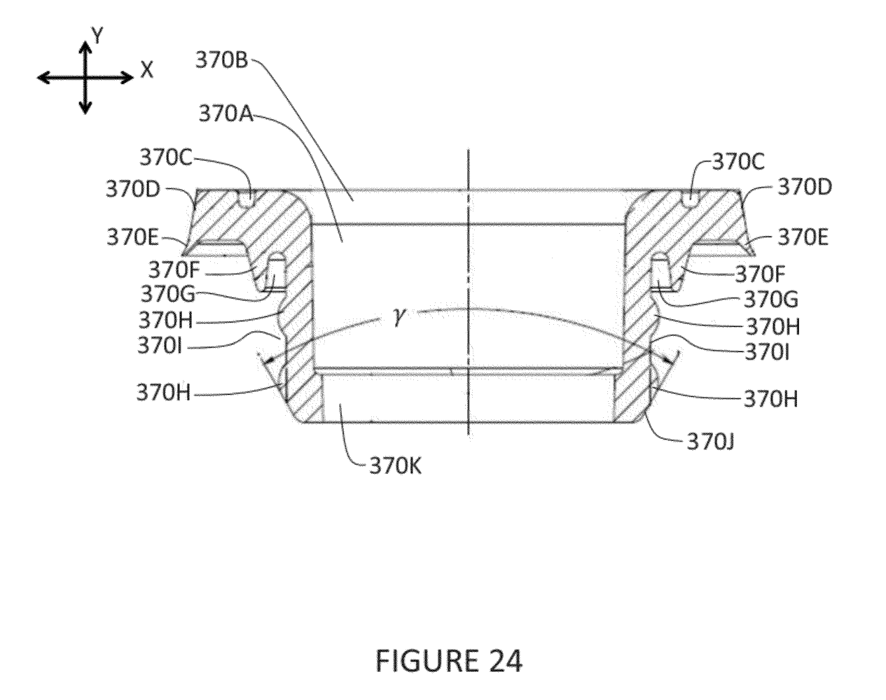

SEAL MEMBER: The cap system 350 may also include a seal member 370 that fits into cap 360, i.e., sized to sleeve over the seal support 364D and fit snugly within a barrel of the cap 360 formed by the finger portions 362 and abut against a lower side of the web portion 364 of the cap and pressed upwardly against an underside of the web portion 364 of the cap 360. As shown in FIGS. 23A, 23B, and 24, the seal member 370 may include a seal channel 370A, a channel surface 370B, a seal groove 370C, a peripheral surface 370D, an outer wall 370E, a seal flange 370F, a flange channel 370G, one or more seal ribs 370H, a rib channel 370I, an insertion surface 370J, and a protruding wall 370K. The seal member 370 is resilient and preferably fabricated of an elastomeric material, such as, by way of example only, thermoplastic rubber (TPR) (molded rubber), SBR, neoprene rubber, or closed cell foam. The seal member 370 of the embodiment of FIG. 17, unlike seal member assembly 170 of the embodiment of FIG. 11, may be composed of one part rather than multiple components, which can provide better sealing. The support previously provided by rigid member 174 of seal member assembly 170 may instead be provided by seal support 364D. The seal member of this embodiment also preferably lacks the kidney-shaped bosses of the prior embodiment(s).

The seal channel 370A may extend from a first end to a second end of the seal member 370, and be configured to permit the passage of fluid through cap system 350. The seal channel 370A may be defined by channel surface 370B. The first end may be formed with the seal groove 370C, which may be configured to receive and engage positioning flange 364E to assist with aligning, securing, orienting, or otherwise positioning seal member 370 and to from a better seal by friction fit therein, by greater surface area of these mating portions and by the change in direction of the path on which the parts mate.

The peripheral surface 370D is preferably configured to abut against a base of each of the finger portions 362. The outer wall 370E preferably extends from the peripheral surface 370D downwards away from the first end formed with seal groove 370C, and outward away from a central axis of seal member 370 to frictionally engage an inner portion of cap 360. The outer wall 370E preferably tapers as it extends, and is angled away from a central axis of seal member 370 at a greater angle than the peripheral surface 370D to provide a tighter fit and increased friction between outer wall 370E and finger portions 362 to better retain the seal member 370 within the cap 360. The outer wall 370E may tend to expand if the seal member 370 is withdrawn from the cap 360. The peripheral surface 370D is preferably angled so as to taper outwardly (in the downward direction away from the nipple) to help seat into the cap.

The seal flange 370F preferably extends away from the web portion 374 and away from ring portion 366. The seal flange 370F is preferably configured to sleeve over an open mouth of a bottle, and the flange channel 370G may be configured to receive the open mouth of the bottle when the bottle is engaged with the cap system 350. The seal flange 370F has an angle outward to help receive the bottle mouth. The one or more seal ribs 370H preferably are configured to abut against an inner wall of a bottle and thus accommodate various bottle neck sizes and shapes while leaving room between each seal rib (at rib channel 370I) for the elastomer to compress and deform to the appropriate bottle neck size, and the rib channel 370I may permit adjacent seal ribs 370H to compress and expand when abutted against the inner wall of the bottle. The insertion surface 370J is preferably disposed at the second end of the seal member 370, and angled to assist with alignment of the cap system 350 with a bottle opening prior to engagement of the cap system 350 with the bottle.

In a most preferred embodiment, the insertion surface 370J may be angled at approximately 30 degrees with respect to the Y-axis, or in other words form an angle γ of approximately 60 degrees. Larger or smaller angles may also be used in less preferred embodiments. The protruding wall 370K may extend radially inward into the seal channel 370A from the channel surface 370B, and may be disposed proximate to the second end of the seal member 370. The protruding wall 370K may provide increased frictional interference between the seal member 370 and the seal support 364D when the seal member 370 has been fully engaged with the seal support 364D. The seal member's lower portion is substantially cylindrical and together with portion forming the flange channel 370G, functions like a cork to seal bottles of various sizes. The seal member's lower end at producing wall 370K may wrap around the cap's sleeve at its lower end of the seal support 364D for a good seal. The seal member's structure angle and flexibility of its lower portion enable the seal member to fit bottles having different diameters and different depths. The seal member thus need not necessarily seat exactly on the top of the bottle opening, as the seal member's lower portion functions to seal the bottle.

In a preferred embodiment, the web portion 364 lacks openings. Supplement may be placed in the storage member 410 prior to assembly of the cap 360 with the storage member 410 by holding the storage member upside down, and filling with a proper amount of supplement or other substance. The cap 360, the shuttle valve 390, and an o-ring may be preassembled and the shuttle valve inserted through the storage member 410, and the cap snapped into place with the storage member. The entire assembly may then be turned right side up, and nipple 400 may then be snapped on. Seal member 370 may be installed over the seal support 364D inside the finger portions 362 of the underside of cap 360. In less preferred embodiments, other assembly steps may also be used. In other embodiments, the web portion 364 may include openings through which supplement may be passed through to be stored in the compartment 420A. As with other embodiments, the cap system 350 is preferably intended for single use, but multiple use is possible. The cap system 350 may be assembled and sold with or without supplement, and the user may fill the cap system 350 with supplement, liquids, or other materials. For example, the storage compartment could be filled with compressed gas and/or a substance that when mixed with the bottle contents becomes carbonated or the like to produce a carbonated beverage.

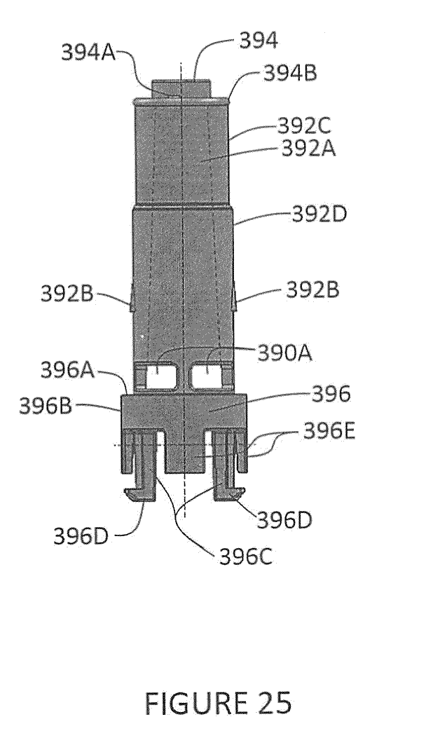

SHUTTLE VALVE: As shown in FIG. 25, the shuttle valve 390 preferably includes a shaft portion 392, a shaft channel 392A, one or more limit members 392B, a valve end 394 configured to engage the nipple 400, one or more valve end openings 394A that may be closed by the nipple 400, a valve end flange 394B, a valve base 396, a base web portion 396A, a base peripheral surface 396B, one or more latching protrusions 396C that preferably are formed with gripping projections 396D, and support projections 396E. The shaft portion 392 preferably includes an upper shaft 392C, a lower shaft 392D, and a shaft shoulder 392E, and the shuttle valve 390 preferably includes one or more shuttle valve openings 390A.

The shaft portion 392 preferably is elongated along a Y-axis, and generally cylindrical. In other embodiments, the shaft may take a variety of forms, such as having a rectangular or elliptical cross section. The valve end 394 preferably includes a protrusion that is configured to extend into and engages with an opening of the nipple 400 to close the cap system 350. The one or more valve end openings 394A are preferably configured to permit fluid and/or other substance flow through the cap system 350 when the nipple 400 is at an open position (e.g., when the protrusion of the valve end 394 has been withdrawn from the opening of nipple 400). The valve end flange 394B preferably is sized to frictionally engage an interior surface of nipple 400, such as an interior wall and/or the interference line 400B such that the nipple 400 is prevented from being removed from the shuttle valve 390.

The shaft portion 392 preferably defines a shaft channel 392A that extends from the one or more valve end openings 394A to an end part of the shaft portion 392 distal to the valve end 394. The upper shaft 392C preferably is connected to the valve end 394, and has an upper shaft diameter that is smaller than the diameter of the valve end flange 394B. The shaft shoulder 392E preferably extends outward away from a center axis of the shuttle valve 390 and away from the base of the upper shaft 392C. The lower shaft 392D preferably extends downward along the Y-axis from the shaft shoulder 392E, and has an external diameter sized to prevent passage of the interference line 400B.

The one or more shuttle valve openings 390A are preferably formed at an end of the shaft portion 392 distal to the valve end 394. In less preferred embodiments, the one or more shuttle valve openings 390A may be disposed at other parts of the shaft portion 392 or in the valve base 396. The one or more limit members 392B are preferably formed on an exterior surface of the shaft portion 392 and are configured to abut against the upper ring portion 366C to limit downward movement of the shuttle valve 390 relative to the cap 360. The one or more limit members 392B preferably extend radially outward from the lower shaft 392D. The one or more limit members 392B preferably further taper towards the valve end 394 to facilitate insertion of the shuttle valve 390 upward through the ring portion 366 of the cap 360 during assembly of the cap system 350.

The valve base 396 preferably is connected to the shaft portion 392 at an end distal to the valve end 394. The valve base 396 preferably is integrally formed with the shaft portion 392, and includes the base web portion 396A and the base peripheral surface 396B. The base web portion 396A preferably extends radially away from the hollow portion 394 in a plane perpendicular to the Y-axis. The base peripheral surface 396B preferably extends from the base web portion 396A along the Y-axis away from the valve end 394, and defines a passage that extends through the valve base 396 and is in fluid communication with the channel defined by the shaft portion 392.

In a most preferred embodiment, the one or more latching protrusions 396C are each biased radially outward from a center axis of the shuttle valve 390 and formed with a gripping projection 396D. Each gripping projection 396D preferably is thus biased radially outward to engage a lowermost edge (bottom) of the seal support 364D (sleeve) when the shuttle valve 390 has been sufficiently lowered relative to the cap 360. The structure including the locking protrusions thus lock the shuttle valve in the open position, even when drinking is taking place, so that the fluid may pass into and out of the storage compartment. This provides an interesting effect, and permits continuous fluid communication of the compartment with the nipple and bottle.

In other embodiments, the latching protrusions 396C may have protrusions and/or recesses configured to engage corresponding tabs, ridges, holes, or other features of the seal support 364D. Each support projection 396E preferably extends from the base peripheral surface 396B and is configured to slide within the seal support 364D while maintaining alignment of the shuttle valve 390 with the cap 360. Each support projection 396E preferably lacks external protrusions to ease sliding movement between the shuttle valve 390 and the cap 360. In the embodiment of FIG. 17, each support projection 396E may be thicker than the tabs 190D of the embodiment of FIG. 11.

In some embodiments, one or more of cap 360 and storage member 410, and the seal member 370 may be integrally formed. Some embodiments may lack the shuttle valve 390, and the cap system 350 may use other mechanisms such as doors, sliding panels, valves, that are known in the art to move the cap system 350 between a mixing state and a non-mixing state.

FIGS. 26A, 26B, and 26C illustrate the cap system 350 at a non-mixing (shipping) position with the nipple 400 lowered, at a mixing position with the nipple 400 lowered (as would normally be done by an end user to cause the shuttle valve openings to align with the openings communicating with the inside of the storage compartment), and at a mixing position with the nipple 400 raised, respectively (so that the nipple opening communicates with the bottle's contents so the end user may drink).

FIG. 26A illustrates the cap system 350 at the non-mixing position, which may be used to transport or sell the cap system 350. In the non-mixing position, the contents of the cap system 350 are retained within the storage member 410, and fluid is prevented from entering the storage member 410. In the embodiment shown, the nipple 400 is lowered such that the protrusion of the valve end 394 extends through and closes the nipple opening 400C and/or covers the one or more valve end openings 394A. The shuttle valve 390 is raised relative to the cap 360 such that base web portion 396A of the valve base 396 is abutted against the ring portion shoulder 366E, the upper ring portion 366C covers the shuttle valve openings 390A, and the base peripheral surface 396B of the valve base 396 covers the one or more cap openings 366A. In other less preferred embodiments, fluid communication between the one or more shuttle valve openings 390A and the one or more cap openings 366A may be blocked by fewer than all of the contacts described above, or through alternate coverings. Preferably, when in the shuttle valve is in the position of FIG. 26A, the inside of the upper ring portion 366C of the cap 360 and the base peripheral surface 396B of the shuttle valve 390 have an interference fit sufficient to provide a moisture seal there between, so that where the bottle contains liquid and the storage container has supplement, moisture will not prematurely mix with and/or degrade the supplement.

The latching protrusions 396C may be deflected radially inward by contact between the gripping projections 396D and the inner surface of the seal support 364D, and alignment of the shuttle valve 390 within the cap 360 and the storage member 410 may be assisted by contact between the support projections 396E and the inner surface of the seal support 364D. The seal member 370 may be sleeved over the seal support 364D and inserted into the cap 360 to abut against the web portion 364 between the seal support 364D and the finger portions 362. The seal groove 370C of the seal member 370 may be engaged with the positioning flange 364E of the cap 360 to orient and fix the seal member 370 within the cap 360.

In some embodiments, the cap system 350 would be shipped in a locked position to prevent the shuttle valve 390 from being accidentally lowered with respect to the cap 360 from the non-mixing position to the mixing position. The cap system 350 could be released from the locked position through rotation of one or more of the nipple 400 and the shuttle valve 390. For example, the shuttle valve 390 and the cap 360 may include mating lockable protrusions (not shown) that could be engaged prior to shipment. The shuttle valve 390 could then be rotated around an axis shared by the cap 360 to disengage the lockable protrusions to allow relative vertical movement between the shuttle valve 390 and the cap 360, which would permit movement of the cap system 350 from a non-mixing position to a mixing position. This lock system may be like the lock system of a liquid soap container or a hand lotion contain, where the shuttle valve cannot be pushed downward but by rotating or twisting the dispenser's outlet, e.g., a quarter turn, the shuttle valve can be pushed.

FIG. 26B illustrates the cap system 350 at a mixing position with the nipple 400 lowered/closed. From the position shown in FIG. 26A, the position shown in FIG. 26B may be reached by pressing against the nipple 400 and/or the valve end 394 to move the shuttle valve 390 downward with respect to the cap 360 until the gripping projections 396D of the latching protrusions 396C are moved past the lower edge of the seal support 364D. The gripping projections 396D then move radially outward (due to their bias) to engage the seal support 364D, and to thereby prevent the shuttle valve 390 from being raised with respect to the cap 360. The limit members 392B may engage the upper ring portion 366C to prevent the shuttle valve 390 from being lowered past a threshold. The mixing position permits movement of supplement and/or fluid between storage member 410 and the shaft channel 392A of the shuttle valve 390. In a most preferred embodiment, the mixing position occurs when the one or more shuttle valve openings 390A are no longer covered by the upper ring portion 366C, the ring portion shoulder 366E is separated from the base web portion 396A of the valve base 396, and the one or more cap openings 366A are no longer covered by the base peripheral surface 396B. Thus, the shuttle valve openings 390A communicate with the cap openings 366A, and the contents of the bottle may pass up through the shuttle valve into the storage container, and the contents of the storage container may pass into the bottle through the shuttle valve. Mixing may thus occur.

In other embodiments, the mixing position may be reached when fluid communication is permitted between storage member 410 and shaft channel 392A of shuttle valve 390 through one or more of the above disengagement and/or uncovering operations. With nipple 400 at a lowered/closed position to prevent fluid from passing through nipple opening 400C, cap system 350 may be engaged with a fluid-filled bottle to be mixed with supplement.

The cap system 350 may be engaged with a bottle by being pressed against an open bottle top. (In a less preferred embodiment, it maybe screwed onto the top of the bottle.) The cap system 350 preferably includes the finger portions 362 that are deflected outward over bottle top threads and/or flanges as the cap system 350 is moved downward over the bottle. In other embodiments, the cap system 350 may include threaded portions that engage the threads of a bottle, or may lack the finger portions 362 and simply be inserted into the top of a bottle. Other mechanisms for attaching the cap system 350 to a bottle may also be used.

As shown in FIG. 26C, after mixing has been completed, the nipple 400 may be raised, permitting a user to drink fluid from a bottle connected to the cap system 350 that has been mixed with supplement in the storage member 410. The nipple 400 may be prevented from being disconnected from the cap system 350 by engagement between the interference line 400B and the valve end flange 394B. The nipple 400 may remain at the raised position due to frictional engagement between the one or more protrusions 400A and the upper shaft 392C. While the nipple 400 is at the raised/open position, fluid may be permitted to travel from a bottle connected to the cap system 350, through the shaft channel 392A of the shuttle valve 390, through the one or more valve end openings 394A, and out through the nipple opening 400C.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. Simple variations might be changing the exterior shape of the storage container to be cartoon characters, animals or other shapes, or making the container clear, opaque, translucent or a combination thereof, and/or using materials other than plastic and rubber as feasible. In addition, it should be understood that aspects of the preferred embodiment(s) generally may be interchanged in whole or in part.

What is claimed is:

1. A dispensing cap system for dispensing a supplement material through a bottle neck opening of a bottle, comprising:
a cap including an upper portion and a connection structure, wherein the connection structure has an engagement mechanism to engage threads of a neck of the bottle;
a seal member disposed inside the cap having a seal surface arranged for sealing contact with the bottle neck,
said connection structure comprising a set of finger portions depending downwardly from the upper portion, the finger portions having finger barb portions extending inwardly, the cap having sufficient flexibility for the distal ends to splay outwardly to allow the barb portions to each pass over a projection of a neck as the cap is installed onto the neck, and such that the barb portions engage the projection to secure the cap onto the bottle neck.

2. The system of claim 1, wherein at least some of the finger barb portions are disposed at the distal ends of the finger portions.

3. The system of claim 1, wherein the finger barb portions include a set of barb portions disposed intermediate the finger portions distal ends and the upper portion.

4. The system of claim 1, wherein the finger barb portions include a first set of barb portions located at the distal ends of at least some of said finger portions, and a second set of barb portions located intermediate the distal ends of at least some of said finger portions and the upper portion.

5. The system of claim 1, wherein the seal member is fabricated of an elastomeric material, such that the seal surface is compressible to allow sealing engagement with the bottle neck as the finger portions engage the projection of the bottle neck.

6. The system of claim 1, wherein the seal member includes a rib configured to abut against and seal an inner surface of a bottle neck.

7. The system of claim 1, further comprising:
a storage member assembled to the cap and including an outer wall defining an outer periphery of a storage volume for holding the supplement material; and
a valve member having one or more valve ports and one or more dispensing ports, the valve member configured for sliding movement between a storage position in which the storage volume is sealed and a dispensing position in which one or more dispensing ports in the cap are open to allow the supplement material to pass through from the storage volume.

8. The system of claim 7, wherein the cap has a seal support that extends downward from the web portion, includes a first engagement part, and is configured to extend through and support the seal member, and wherein the valve member includes a second engagement part configured to engage the first engagement part to resist movement of the valve member towards the storage position.

9. The system of claim 1, wherein the cap has a seal support that extends downward from the web portion and is configured to extend through and support the seal member.

10. The system of claim 1, further comprising a valve nipple configured to fit onto the valve for sliding movement between a valve closed position and a valve opened position in which contents of the bottle are allowed to pass through the valve member for consumption by a user.

11. A dispensing cap system for dispensing a supplement material through an opening of a bottle, comprising:
a storage member formed with a cavity for storing and dispensing supplement material;
a valve system connected to the storage member and operable to move the cap system between a mixing state and a non-mixing state, wherein the cavity of the storage member is in fluid communication with the opening of the bottle when it is attached to the cap system and the cap system is at the mixing state, and wherein the cavity of the storage member is not in fluid communication with the opening of the bottle when it is attached to the cap system and the cap system is at the non-mixing state; and
a cap connected to the storage member and configured to engage the bottle opening.

12. The system of claim 11, further comprising a seal member disposed inside the cap and having a seal surface arranged for sealing contact with the bottle neck.

13. The system of claim 11, wherein the cap includes a web portion and a set of finger portions depending downwardly from the upper portion, the finger portions having finger barb portions extending inwardly, the cap having sufficient flexibility for the distal ends to splay outwardly to allow the barb portions to each pass over a projection of a neck as the cap is installed onto the neck, and such that the barb portions engage the projection to secure the cap onto the bottle neck.

14. The system of claim 11, wherein the valve system comprises a shuttle valve formed with one or more valve openings, a shaft, and a shaft channel that is in fluid communication with the one or more valve openings.

15. The system of claim 14, wherein the cap is formed with one or more cap openings, and the cap system is at the non-mixing position when the one or more cap openings are each blocked or the one or more valve openings are each blocked such that the cavity of the storage member will not be in fluid communication with the opening of the bottle when it is attached to the cap system.

16. The system of claim 11, wherein there are means for holding the valve system in the mixing position.

17. The system of claim 11, wherein the cap is formed with one or more cap openings, and the cap system is at the mixing position when the one or more cap openings and the one or more valve openings are in fluid communication.

18. The system of claim 11, wherein the cap includes a web portion, and a seal support that extends downward from the web portion, the seal support being configured to extend through and support the seal member.

19. A dispensing cap system for dispensing a supplement material through a bottle neck opening of a bottle, comprising:
a storage compartment for holding supplement material;
valve means for moving the cap system between a mixing position and a non-mixing position;
holding means for holding the cap system to a bottle to permit mixing of the supplement material with the contents of the bottle when the cap system is at the mixing position.

20. The system of claim 19, further comprising:
drinking means for opening and closing the cap system to permit a user to drink the mixed supplement material and contents of a bottle through the cap system, and a seal member having a lower portion for extending into the bottle and for sealing the cap system from fluid communication with the bottle.
